(19) United States
(12) Patent Application Publication
(10) Pub. No.: US 2010/0046786 A1
(43) Pub. Date: Feb. 25, 2010

(54) PERIPHERAL APPARATUS ASSEMBLY FOR ELECTRONIC DEVICE

(75) Inventor: NIAN-FENG ZHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-cheng (TW)

(21) Appl. No.: 12/504,672

(22) Filed: Jul. 17, 2009

(30) Foreign Application Priority Data
Aug. 25, 2008 (CN) 200810304170.3

(51) Int. Cl. H04R 1/02

(52) U.S. Cl. 381/387

(57) ABSTRACT

A peripheral apparatus assembly for an electronic device includes a base, two speakers and a signal line. The base supports the electronic device. The two speakers rotate with respect to the base to selectively locate at the first position and a second position. Each speaker has a sound surface from which sound waves generated by the speaker radiate. At the first position, the two speakers are parallel to each other, and the two sound surfaces face away from each other. At the second position, the sound surfaces face the same direction as the two speakers. The signal line electrically connects the two speakers to the electronic device.

### BACKGROUND

1. Technical Field

The present disclosure relates to peripheral apparatuses, and particularly to a peripheral apparatus assembly for an electronic device.

2. Description of Related Art

For portability, portable electronic devices, such as notebook computers, media players, are becoming smaller and smaller. Electronic components assembled in the portable electronic device are correspondingly becoming smaller in size. Therefore, some miniaturized components, such as speakers may not be able to perform in a fidelity manner.

For improving effects of the portable electronic devices, users may connect the portable electronic devices to peripheral devices. For example, users may connect a media player to external speakers for improving audio effects. However, some conventional peripheral apparatuses, such as the external speakers, are inconvenient to carry with the portable electronic devices.

Therefore, there is room for improvement within the art; a new peripheral apparatus assembly for portable electronic devices is desired.

### BRIEF DESCRIPTION OF THE DRAWINGS

FIG. 1 is an isometric view of a peripheral apparatus assembly for an electronic device in accordance with an exemplary embodiment.

FIG. 2 is an exploded view of the peripheral apparatus assembly in FIG. 1.

FIG. 3 is an isometric view of the peripheral apparatus assembly in FIG. 1 assembling with the electronic device together during use.

FIG. 4 is an enlarged view of a circled portion IV of FIG. 2.

### DETAILED DESCRIPTION

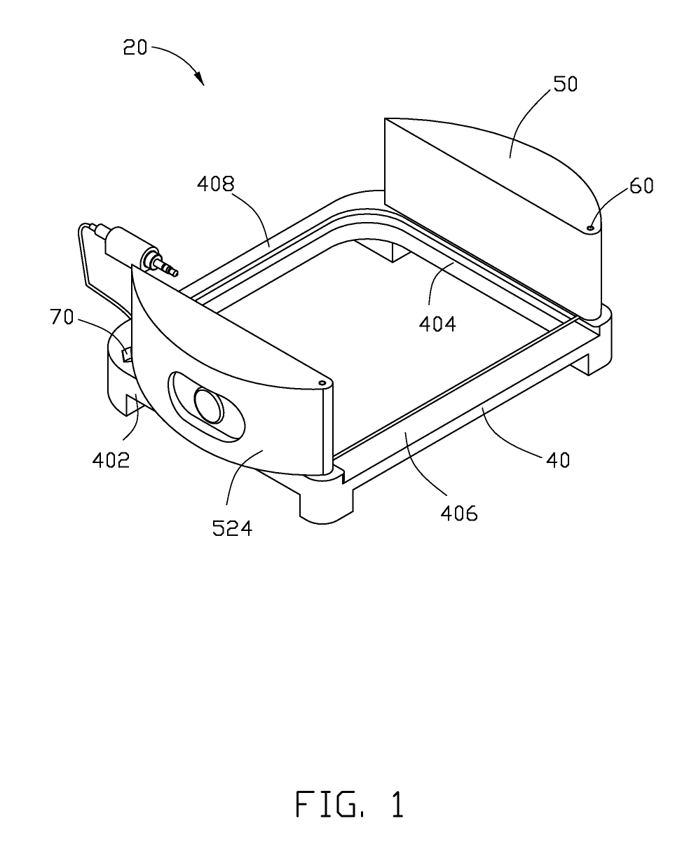

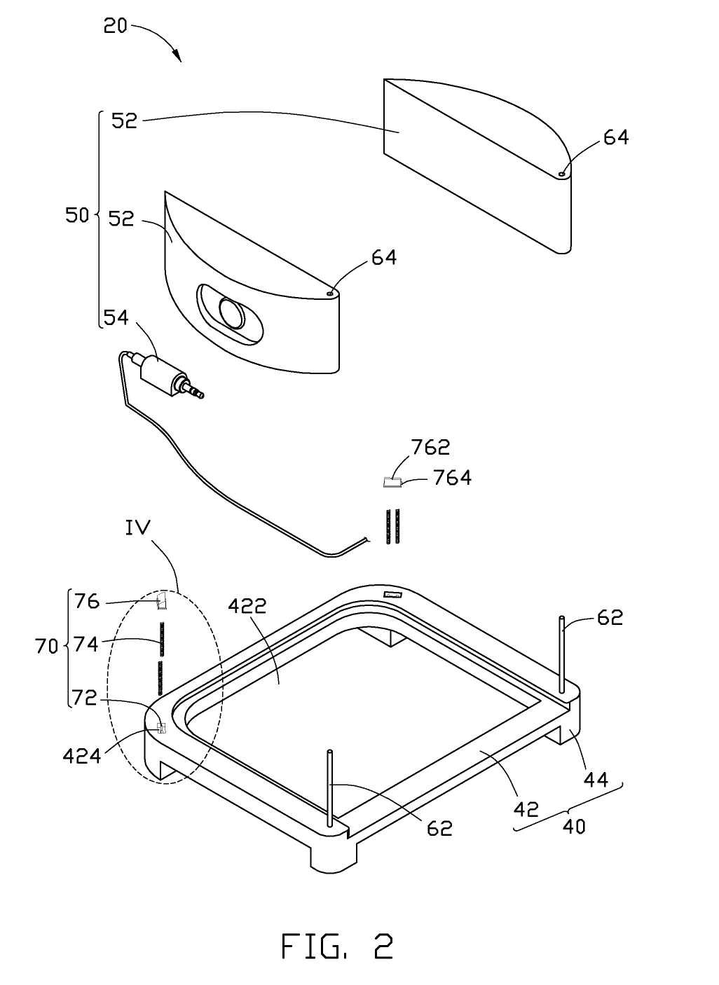

Referring to FIGS. 1 to 3, a peripheral apparatus assembly 20 is capable of connecting to an electronic device 10 for improving specific qualities of the electronic device 10. The electronic device 10 may be a notebook computer, a media player, a panel personal computer, and so on. In this embodiment, the peripheral apparatus assembly 20 is a sound box assembly.

The peripheral apparatus assembly 20 includes a base 40, a peripheral apparatus 50, two pivotal mechanisms 60 and two restriction mechanisms 70. The pivotal mechanisms 60 rotatably connect the peripheral apparatus 50 to the base 40. The restriction mechanisms 70 restrict the peripheral apparatus 50 on the base 40.

The base 40 includes a seat 42, four legs 44 extending downwardly from the seat 42. The seat 42 is substantially rectangular for supporting the electronic device 10. The seat 42 may be a frame with four beams, e.g. a first beam 402, a second beam 404, a third beam 406, and a fourth beam 408. The four beams 402, 406, 404, and 408 interconnect with each other, and enclose an opening 422. The first beam 402 is substantially parallel to the second beam 404. The third beam 406 is substantially parallel to the fourth beam 408. Two recesses 424 are defined in the first beam 402 and the second beam 404 correspondingly. The two recesses 424 are adjacent to the fourth beam 408.

The four legs 44 are correspondingly located at four corners of the seat 42 to support the seat 42. The four legs 44 are parallel to each other. The four legs 44 are perpendicular to the seat 42.

The peripheral apparatus 50 includes two speakers 52 and a signal line 54 electrically connecting the two speakers 52 to the electronic device 10. Each speaker 52 has a curved sound surface 524 from which sound waves generated by the speaker 52 radiate.

Each pivotal mechanism 60 includes a shaft 62 mounted on the base 40 and a shaft hole 64 defined in one end of the speaker 52. The two shafts 62 of the two pivotal mechanisms 60 are arranged on opposite ends of the third beam 406 of the seat 42 and substantially perpendicular to the third beam 406. The shafts 62 and the legs 44 are arranged at opposite sides of the seat 42. The two shafts 62 are inserted into the two shaft holes 64 correspondingly to rotatably connect the two speakers 52 with the base 40, thus each speaker 52 is rotatable with respect to the seat 42 to selectively position the speaker 52 in a first position and a second position.

At the first position (referring to FIG. 1), the two speakers 52 are substantially on the first beam 402 and the second beam 404 correspondingly. The two speakers 52 are parallel to each other. The sound surfaces 524 face away from each other. When rotating the two speakers 52 away from the first beam 402 and the second beam 404 correspondingly, the two speakers 52 can locate at the second position.

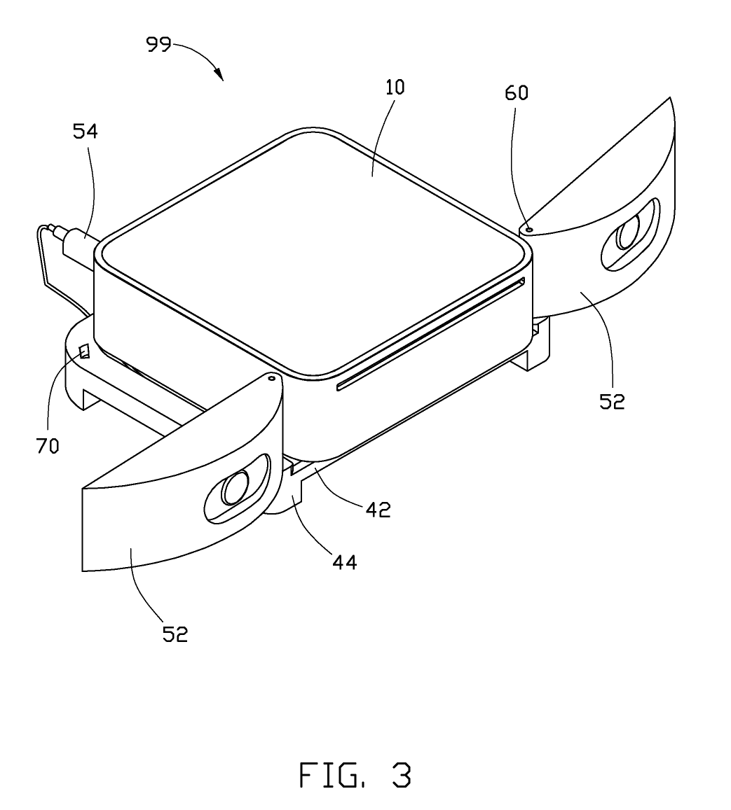

At the second position (referring to FIG. 3), the two speakers 52 are parallel to the third beam 406. The first beam 402 and the second beam 404 is between the two speakers 52. The sound surfaces 524 are in the same side of the two speakers 52. The sound surfaces 524 face the same direction. When rotating the two speakers 52 towards the first beam 402 and the second beam 404 correspondingly, the two speakers 52 can return to the first position.

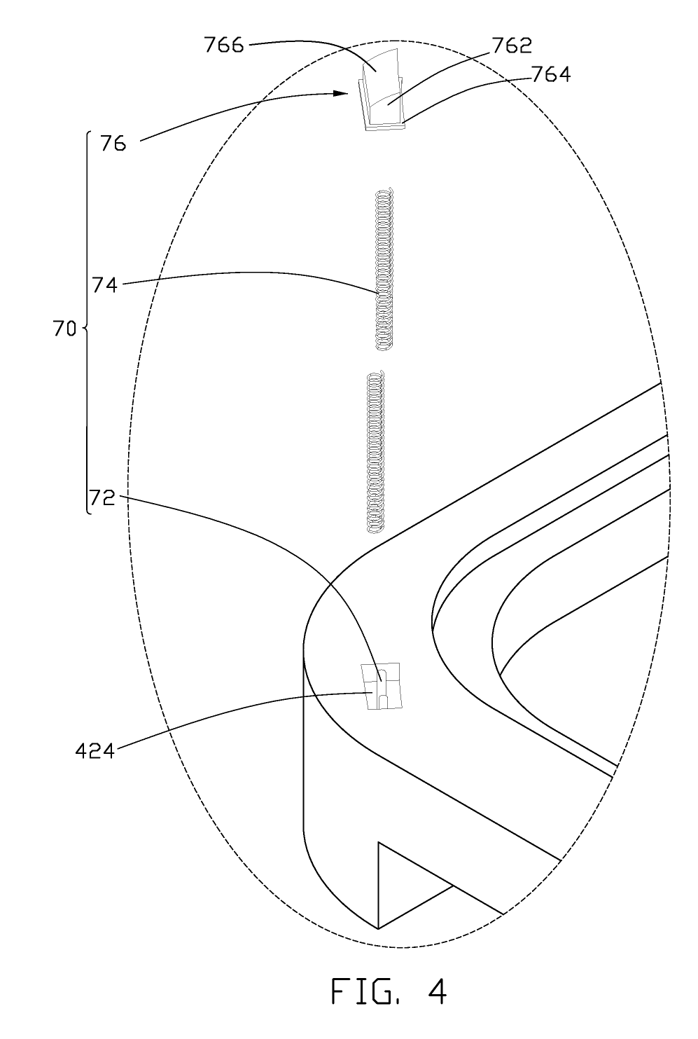

Referring to FIG. 4, the two restriction mechanisms 70 are partially received in the two recesses 424. Each restriction mechanism 70 includes two fixing poles 72 mounted in the recesses 424, two springs 74 sleeved on the two fixing poles 72 correspondingly, and a button 76.

The button 76 is sleeved on free ends of the two fixing poles 72 and contacts the two springs 74. The button 76 includes a main body 762, and a rim 764 protruding from one end of the main body 762. The main body 762 has an oblique guiding surface 766 away from the rim 764. The rim 764 is contact with the springs 74.

The main body 762 defines two pole holes (not shown) in the end of the main body 762. The two fixing poles 72 are inserted into two pole holes, thus the button 76 is sleeved on the two fixing poles 72, and is movable up and down along the two fixing poles 72 to selectively locate in a first state and a second state.

In the first state, the button 76 protrudes out of the base 40. The rim 764 is sandwiched between the springs 74 and the base 40 around the recess 424, thus the button 76 balances between the two springs 74 and the base 40. Meanwhile, when the two speakers 52 are at the first position, the two buttons 76 are in the first state and contact with the sound surfaces 524 of the two speakers 52 correspondingly, thus the two buttons 76 can restrict the corresponding speaker 52 to the first position.

When the two buttons 76 are pressed by an external force to move downwards along the corresponding two fixing poles 72, the two buttons 76 can be changed from the first state to the second state. In the second state, the buttons 76 are completely received in the two recesses 424. The springs 74 are compressed to generate restoring forces. The two speakers 52 can be rotated, and switched between the first position and the second position. Once the external force is released, the two buttons 76 moves upwards along the corresponding two fixing poles, and change from the second state to the first state via the restoring force generated by the springs 74.

In use, the electronic device 10 is arranged on the base 40, the peripheral apparatus 50 is connected to the base 40 and electrically connected with the electronic device 10, thus the electronic device 10 and the peripheral apparatus 50 can conveniently move with the base 40 together.

In addition, when a user of the electronic device 10 use the speakers 52 to play audio files, the user can face the sound surfaces 524 of the two speakers 52, thus audio heard from the speakers 52 has better quality.

Furthermore, when the speakers 52 are changed from the second position to the first position, the speakers 52 contact the guiding surfaces 766 of the two buttons 76 correspondingly, thus the buttons 76 are pressed and changed from the first state to the second state, the user need not press the two buttons 76 by hand.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A peripheral apparatus assembly for an electronic device comprising:
a base supporting the electronic device;
two speakers configured to rotate with respect to the base and to selectively locate at a first position and a second position; each speaker having a sound surface from which sound waves generated by the speaker radiate; in the first position, the two speakers being parallel to each other, and the two sound surfaces facing away from each other; in the second position, the two sound surfaces facing the same direction; and
a signal line electrically connecting the two speakers to the electronic device.

2. The peripheral apparatus assembly according to claim 1, further comprising two restriction mechanisms partially protruded out of the base to restrict the two speakers on the base correspondingly.

3. The peripheral apparatus assembly according to claim 2, wherein the base defines two recesses, and the two restriction mechanisms are received in the two recesses.

4. The peripheral apparatus assembly according to claim 3, wherein each restriction mechanism comprises a fixing pole received in the recess, a spring sleeved on the fixing pole, and a button sleeved on the free end of the fixing pole and contacting with the spring; and the button is movable along the fixing pole.

5. The peripheral apparatus assembly according to claim 4, wherein the button comprises a main body and a rim protruding from one end of the main body; and the rim is sandwiched between the spring and the base around the recess.

6. The peripheral apparatus assembly according to claim 1, wherein the base comprises a seat supporting the electronic device and at least one leg supporting the seat.

7. The peripheral apparatus assembly according to claim 6, wherein the base is substantially rectangular, the at least one leg is four legs; and the four legs are downwardly extended from the seat and arranged at four corners of the seat.

8. The peripheral apparatus assembly according to claim 7, wherein the seat defines an opening therein.

9. A peripheral apparatus assembly for an electronic device comprising:
a base, supporting the electronic device thereon, comprising a first beam, and a second beam opposite to the first beam; and
two peripheral components configured to rotate with respect to the base and to selectively locate at a first position and a second position; in the first position, the two peripheral components being arranged on the first beam and the second beam correspondingly; in the second position, the first beam and the second beam being between the two peripheral components.

10. The peripheral apparatus assembly according to claim 9, wherein the base defines two recesses in the first beam and the second beam correspondingly; and the peripheral apparatus assembly comprises two restriction mechanisms mounted in the two recesses capable of partially protruding out of the two recesses to restrict the two peripheral components on the base correspondingly.

11. The peripheral apparatus assembly according to claim 10, wherein each restriction mechanism comprises a button which is movable in the corresponding recess to selectively be in a first state and a second state; in the first state, the button partially protrude out of the recess; and in the second state, the button is completely received in the recess.

12. The peripheral apparatus assembly according to claim 11, wherein each restriction mechanism further comprises a fixing pole mounted in the recess, and a spring sleeved on the fixing pole; and the button sleeved on free end of the fixing pole and contacting with the spring is movable along the fixing pole to selectively locate in the first state and the second state.

13. The peripheral apparatus assembly according to claim 12, wherein the button comprises a main body and a rim protruding from one end of the main body; and the rim is sandwiched between the spring and the base around the recess.

14. The peripheral apparatus assembly according to claim 13, wherein the main body has an oblique guiding surface away from the rim.

15. The peripheral apparatus assembly according to claim 11, wherein the peripheral component can be rotated and switched between the first position and the second position when the button is in the second state.

16. An assembly mechanism comprising:
an electronic device;
a base supporting the electronic device; and
a peripheral apparatus rotatably connected to the base capable of electrically connecting to the electronic device.

17. The mechanism according to claim 16, further comprising a restriction mechanism capable of partially protruding out of the base to restrict the peripheral apparatus on the base.

18. The mechanism according to claim 17, wherein the base defines a recess, and the restriction mechanism is received in the recess, and capable of partially protruding out of the base to contact the peripheral apparatus.

19. The mechanism according to claim 18, wherein the restriction mechanism comprises a fixing pole received in the recess, a spring sleeved on the fixing pole, and a button sleeved on the free end of the fixing pole and contacting with the spring; and the button is movable along the fixing pole.

20. The mechanism according to claim 19, wherein the button comprises a main body and a rim protruding from one end of the main body; and the rim is sandwiched between the spring and the base around the recess.
